(19) United States
(12) Patent Application Publication
(10) Pub. No.: US 2016/0198300 A1
(43) Pub. Date: Jul. 7, 2016

(54) Mobile Device Distance Measurement and Object Identification by Utilizing the Rotation Vector and Accelerometer

(71) Applicant: Shimon Rothschild, Dallas, TX (US)

(72) Inventor: Shimon Rothschild, Dallas, TX (US)

(21) Appl. No.: 14/590,960

(22) Filed: Jan. 6, 2015

(51) Int. Cl. H04W 4/02; H04M 1/725; H04W 4/00

(52) U.S. Cl. CPC H04W 4/023; H04W 4/021; H04W 4/005; H04M 1/72544; H04M 1/72569

(57) ABSTRACT

A mobile device utilizing on-board sensors capturing a rotation vector, the GPS position and an accelerometer is used as a pointing device. Pointing a mobile device in the direction of an object and tilt the device to signify distance, objects can be selected by establishing the GPS coordinates of the object. Tilt of the phone relative to any maximum range defined, will proportionally define the intended range by the tilt angle as proportional representation in distance. Compass direction is supplemented by the tilt angle to calculate the true direction (A compass works when it is level with the ground, the tilt causes significant deviation). With the direction and distance and utilizing the GPS position reading in the mobile device, a second GPS coordinate can be calculated. This GPS coordinate is then matched to objects located in that location. The details of the object selected are displayed on the mobile device.

### REFERENCES CITED

### U.S. Patent Documents

| | | | |
|---|---|---|---|
| 8,923,650 | Dec. 30, 2014 | Wexler | Measuring digital |
| | | | images |
| 7,946,921 | May 24, 2011 | Ofek, et al. | On board |
| | | | camera used for |
| | | | hand held game |
| | | | device |
| 8,506,404 | Aug. 13, 2013 | Distanik, et al | Wireless gaming |
| | | | method short |
| | | | range wireless |
| | | | for multiplayer |
| | | | using the |
| | | | camera |
| 2012/0200491 | Aug. 9, 2012 | Miller, IV; | Gestures |
| | | Thomas M. | recognized from |
| | | | motion data |

### SUBSTITUTE SPECIFICATION STATEMENT

This substitute specification includes no new matter.

### DESCRIPTION

### Field of the Invention

The present invention relates generally to electronics and more specifically to mobile electronics. The invention relates particularly to mobile device hand-held systems via sensor inputs from device movement.

### EXAMPLE 1

The present example is a game where the game generates a target on an actual map, based on centering on the user GPS location. The user points the phone in the direction of the computer generated target (compass) and holds the phone at an angle to indicate the trajectory. Based on the compass direction, the trajectory, parabola in a vacuum, and the type of projectile selected (low, medium or high radius) the player may miss, hit, damage or destroy the target. The game repeats with new targets, maps and weapons.

### EXAMPLE 2

The present example is a tool to identify the registered residents in a home. The user points the phone at a dwelling and the algorithms determine what home is selected based on location of the user and the direction the phone is pointed. The algorithms identify the coordinates of the home and using third party services can display to the user information about the residents, home value and other details associated with by the house and the names listed as residents.

### EXAMPLE 3

The present example is a social interaction game where multiple users appear on the same map. By aiming at a person, information about that person can be displayed. In this scenario, it is like laser tag, or paint ball, point the phone at the target, the invention calculates if it is a “hit” and lets both individuals know the result.

### BACKGROUND OF THE INVENTION

Until now there has been no application of a mobile device as a pointing device. For both games and real world applications it would be very useful to incorporate this functionality into a mobile device. Hardware limitations have discouraged implementation. Mobile devices do not have the hardware to intuitively measure distances. Mobile device technology has evolved from Internet browsers and web pages, device hardware is much more capable. This problem could not be addressed on a desktop PC and pointing a notebook at a house (or even using the notebook GPS functionary) is not intuitive. The shape of a mobile phone (for example) is similar to the shape of many remote controls. To control a room heater or air conditioner, point the remote at the unit and press the appropriate control button. Using a remote control to channel surf a television and control the volume is a very familiar paradigm. Given an opportunity, people want to know about their neighbors, but in this day and age, information at the fingertip is the preferred method. If not immediately available, then it is perceived as significant effort. This invention enables user to immediately learn about their neighbors (and anyone) by point and click. Data is now immediately available.

Information about places and people has become generally available to everyone through the internet. The process, however, is multi-step, not intuitive and retrieval from different services requires learning their specific steps to access the data. Here is an example:

An individual wants details about a new neighbor.

How much did they buy the house for? Go to the web site of the county assessor, enter the address and the web site displays the results. User input must be correctly formatted, not intuitive, to get a result returned.

What are the names and phone numbers of the people living there? Go to a web site identify the home on the top down map (can you identify a house by its roof?) select the home and name and phone number information is displayed. This invention as a byproduct has also this functionality, but it is not new.

View social media information about the new neighbors: Go to each social media website (Facebook, Google+, Twitter and LinkedIn) enter each residents name, and view their profile.

Does the neighbor have a criminal record? Go to a web site that identifies criminals and enter the name. The web site returns any convictions or if the person is a registered sex offender. This invention does not currently implement this functionality, but it would be easy to do this.

What if an individual is driving by a home and are curious to know who lives there? Following the steps above from a car would be difficult. An emergency unit (police, rescue etc.) could use it to identify a location and connect to a proprietary data service for information specific to their requirements. No need to type data into a computer, point and view.

This invention provides these details based on the GPS location of the object. Point the mobile device at the object and using the device sensors the GPS location of the object is determined. From the GPS location, details about the objects and sub objects can be obtained.

As a tool, GPS location based object identification can be accomplished by pointing the mobile device in the direction of the object. The challenge remains how to determine the distance of the object from the mobile device. This is accomplished by a combination of phone tilt (angle) and scale of the area of operation. The same logic can also be applied to a game of tag.

Game players benefit by having an original game. The mobile device functions as a virtual paint ball gun, where multiple players on a map move around and shoot at other targets on the map. This is a base implementation, but it proves the validity of the invention. The game can be played solo where targets are generated and the objective is to hit the target in the fewest shots. The game now exists and it works as expressed. A future version will be multiplayer where users log into a game and play against people in the neighborhood.

### SUMMARY OF THE INVENTION

Implementation of range finding with a mobile device. Utilizing device sensors, any GPS location may be selected by direction and tilt of the device. The location can be compared with data sets to discover the details of the object at that location. In some scenarios it can be used to view data about a building. In other scenarios it can be a game, where players are moving targets and the mobile device works as would a paint-ball gun. Point and tilt to hit the target. If a miss identify where the shot landed for the player to adjust direction and angle.

### BRIEF DESCRIPTION OF THE DRAWINGS

The foregoing and other objects, aspects and advantages will be better understood from the following detailed description with reference to the drawings, in which:

FIG. 1: A data flow diagram demonstrating how the invention uses hardware and databases to determine the intended object. This works for any object where the user arbitrarily selects and object (item) for identification.

FIG. 2: A data flow diagram demonstrating the subtle difference where the user must hit a target. The difference is that it does not matter the object type, only if the shot is close enough to impact the target.

FIG. 3: A process flow with the distinct phases and the operations in each phase. It is specific to target acquisition. The phases are broken down according to data requirements and operations on the data.

FIG. 4: State diagram which is tightly coupled to screens and key operations. These is generic for any use, game target or user selected target (object to discover), stationary or movable object. Screen shots of applications that implement the invention using the state flow diagram.

FIG. 5: An activity diagram demonstrating how user, target, device and application interact to initiate, operate and identify if the target is hit. User, device and target can be in motion independently and the data capture is at the instant the user instructs the application to measure if the shot is inside the radius of the target.

FIG. 6: A sketch demonstration of how a user will use the invention to aim and set range with the mobile device.

### DETAILED DESCRIPTION OF ILLUSTRATIVE EMBODIMENTS

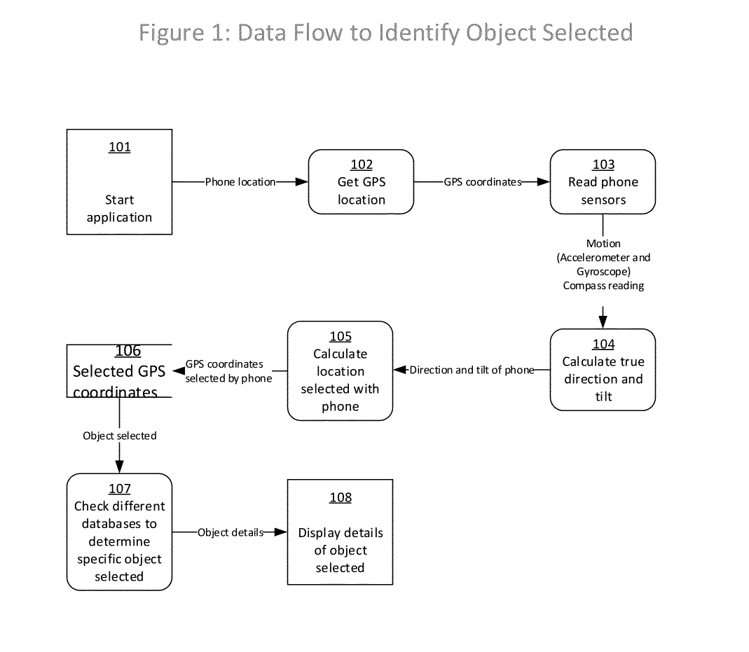

### FIG. 1:

101: Download the application from the application store. These are run by the operating system owners (Google Android, Apple iPhone or Microsoft Windows). It can be downloaded from hardware vendors who also have application stores (Samsung, HTC). There may also be customized versions that are distributed independently. The pre-requisite is that the hardware must have the required sensors and support for 3rd party software as required (Google “Play” account for Android). User must accept that the application will access sensors, use Wi-Fi or cellular data and store data in the phone.

102: Based on the device location, read the GPS sensor location. The coordinate is a globally unique position on Earth. This is required to calculate what object is being selected. GPS position is used as the starting position for determining what direction and how far is the object that is selected. GPS service must be enabled by the user and the device must be in a location with sufficient GPS satellite coverage. With sufficient coverage GPS position accuracy can be within one meter. With poor coverage it may be off as much as one kilometer. Without a GPS reading, it can use the last known position (which may be obsolete). Otherwise the flow ends here. In instances where the device is indoors or under a blocking object (tree, tall building) and there is no GPS reception, the flow ends and the user may not proceed. GPS services

103: Using built in capabilities of the phone read sensors. There is no sensor for phone angle and it must be calculated from other sensors. There is no infra-red or other specialized sensor to measure distance of an object from the device. If there is only the compass reading there are two options, assume a fixed distance or continue a straight line in the direction until an object is discovered. Indoor and outdoor return similar results. There was no testing for the impact of altitude (there is a sensor for this), and the calculation for true direction and tilt do not compensate for altitude. Phone sensor reading to use the phone as a pointing device is one of the two fundamental inventions.

104: A compass reading is only accurate when the phone (or compass) is parallel to the earth surface (no tilt). Therefore the direction must be calculated to reflect the phone tilt. From the phone get the following sensor parameters:

### Rotation Vector

### Accelerometer

105: The greater the map scale the less accurate user selection (this is true in real world target acquisition as well). There can be compensation with a zoom capability which would simulate phone location closer to the target. Based on the map scale the distance from the phone is the ratio of phone tilt over maximum range where maximum range is about 90 degrees (phone perpendicular to the ground). The direction is from the rotation vector (compass axis). As a ratio, the optimal tilt can be modified. Some users prefer 45 degrees, it can be user configurable. Some phone have a compass sensor and it can be used when phone tilt is not available. In this scenario, distance is fixed or until an object is found.

106: The formula is a standard trig function. Based on a formula, the following parameters are used:

Current location

### Direction

### Distance

Using trigonometry, the destination point is calculated

107: Pass the selected GPS coordinates to different databases to discover the type of object selected, If a match the description is provided. Specific implementations could make an assumption that the object is a particular type and get the description. If not found return nothing. Capability is without limit except for limitation of available data to match object to GPS coordinate. Future application could include person recognition. If the database knows what person is at the GPS location then details of the person can be provided.

108: Show the details of the object on the phone screen. For example a house might include residents, phone number and details about each resident from the social networks. For predefined object assumption, further assumptions can be made about distance from phone. For example, a phone pointed at a house will be in the same neighborhood. This allows greater accuracy in returning data of the user intended object.

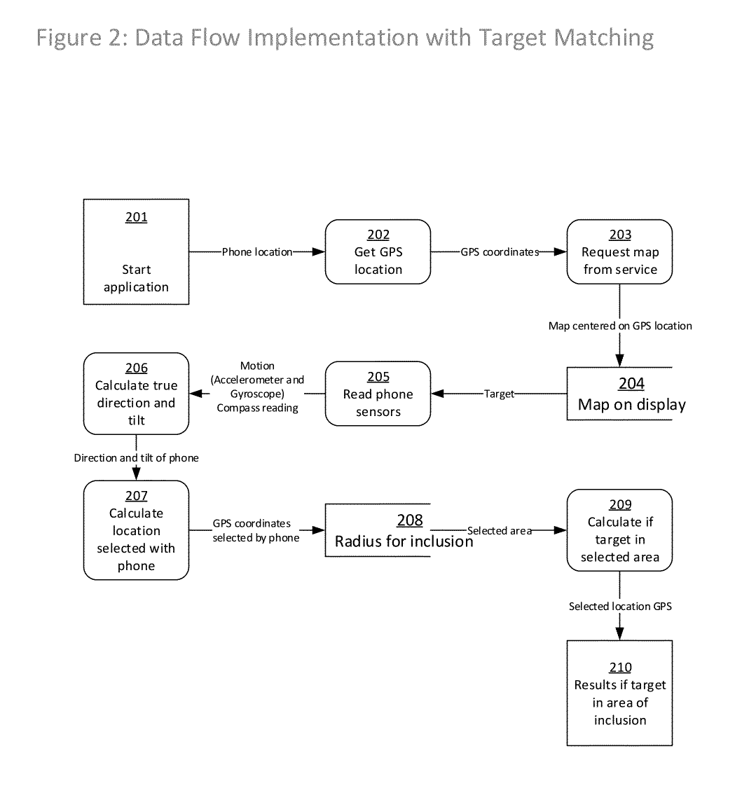

### FIG. 2:

201: As 101

202: Read the GPS coordinates from the phone. The coordinate is a globally unique position on Earth. Without a GPS location, the user could play on a virtual map with the user located on the map. GPS position is used as the starting position for determining what direction and how far is the object that is selected. Using GPS, the service must be enabled by the user and the phone must be in a location with sufficient GPS satellite coverage. With sufficient coverage GPS position accuracy can be within one meter. With poor coverage it may be off as much as one kilometer.

203: There can be an assumption that the phone is in the same location as previously checked. This speeds up map retrieval, but the result could be the wrong map (phone location not visible on the map on display) or user not centered on the map. Center map on GPS location with scale set by user. Maps are freely available from various online sources. Use of a virtual map (game) where the GPS location is positioned on the virtual map. There was difference in speed based on the scale, greater scale sometimes took longer to retrieve.

204: Display the map at the scale selected by the user with the user centered in the map A virtual map might not require that the user be centered for the best user experience.

205: As 103

206: As 104

207: As 105

208: Based on factors:

Map scale
User preference

209: A standard algebraic formula exists to test if a point is within the bounds of a circle (radius from target results in a circle around the target). The implementation is three circles, innermost for highest score, middle and outer. Outside the radius of inclusion is no score (a miss). Hardcode the data radius is an option, then test the distance in pixels from the target.

210: If outside the radius for inclusion show the location selected to enable the user to adjust direction and tilt. If within the radius, indicate that target was selected

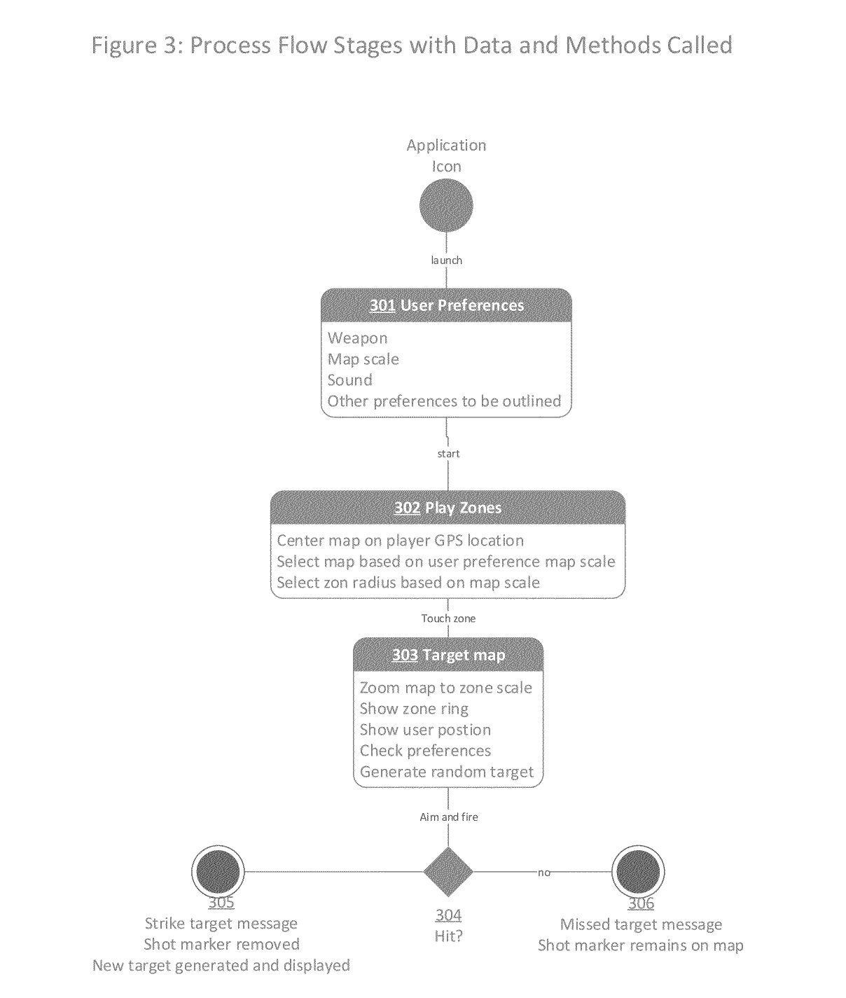

### FIG. 3:

301: User preferences are data values saved to the device. While they can be changed by the user, one gameplay begins they are static for the duration. Some data is game specific such as weapon, maps scale, maximum shots per target and the tutorial screens. Other data such as vibration, sound and GPS tracking are game specific. GPS tracking can be turned off when the user is stationary. This reduces the drain on the device battery.

302: Play zones define the map scale. In specific applications, such as the home identification, scale may be assumed. Based on the GPS location and the map scale, display the map. There is no limitation to the size of a play zone, it could be dynamic to accommodate additional players on the same map (game).

303: The map is displayed based on the radius of the play zone. The map is centered on the device and targets are displayed on the map. The circle representing the radius of game play. At maximum tilt, the selection would be at or slightly outside the circle. This sets the ratio of tilt to distance. Visually, one half tilt would represent one half the distance to the circle from the center. If the user moves away from the center, the user position moves, but the map remains stationary. Distance is measured from the current location of the user and distance remains calculated based on the radius of the circle. The invention could provide that the range be the diameter. Other values are not intuitive to the user.

304: The target has a size (bounding box or radius). The selected GPS location (where the shot lands) has an impact radius. If any portion of the target is within the impact radius, it is a hit.

305: On hit, there may be degrees of impact, depending on the proximity of the target to the center of the impact area. This is displayed to the user on the device that is being used for direction and tilt. Optionally a user may earn points towards virtual rewards (as many games have implemented)

306: On miss, display where the selected location is, thus empowering the user to adjust the direction and tilt.

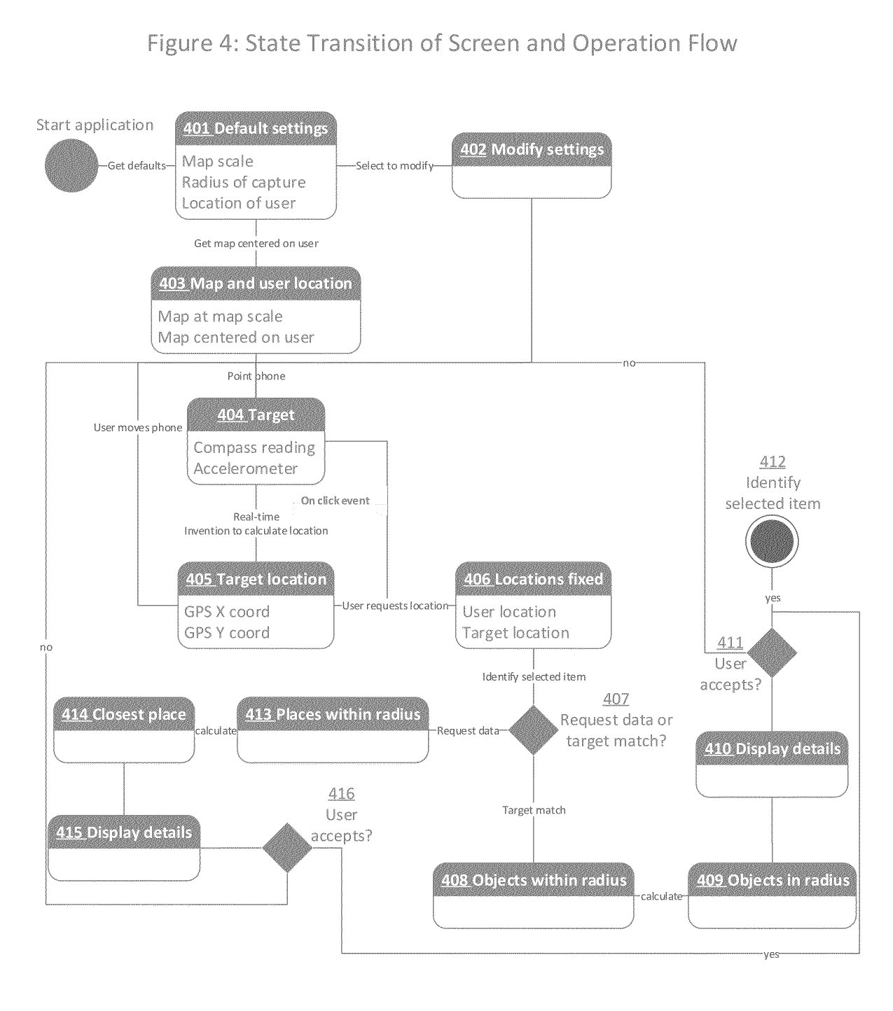

### FIG. 4: See Descriptions at Each Step.

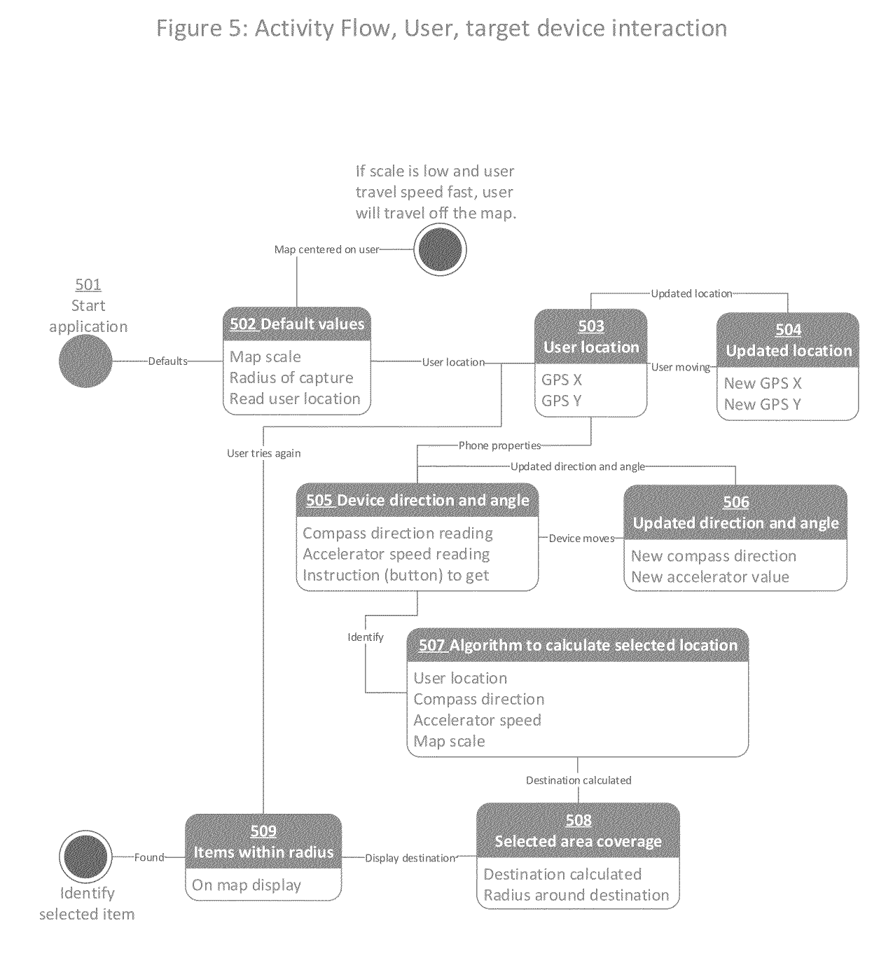

### FIG. 5:

501: As 101

502: As 301

503: As 102

504: The user can move location while holding the device. Location is updated in real-time and tracked on the device map. Measurements to the selected location are based on the last known position of the device.

505: The device direction and angle (tilt) are measured in real-time to enhance the user experience. The values are displayed on the device for the user to more accurately bracket the target. When the button to select the location is pressed, at that instant the direction and tilt are calculated from the device sensor values. These values are inputs into the formula.

506: As the device changes direction or tilt, the device display is updated show the values. Changing direction and tilt has no impact on direction or distance. The velocity (rate of change) is captured, but not currently utilized. In the future it will be, such as throwing a stone. Velocity for distance measurement is included in the invention.

507: As 106

508: As 209

509: As 210

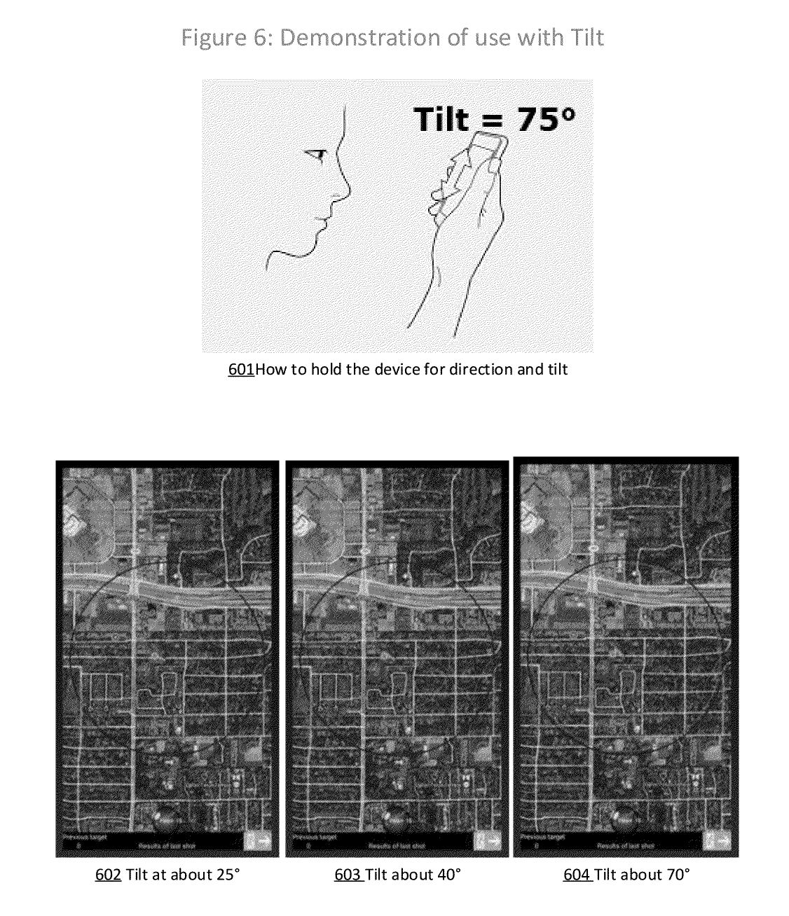

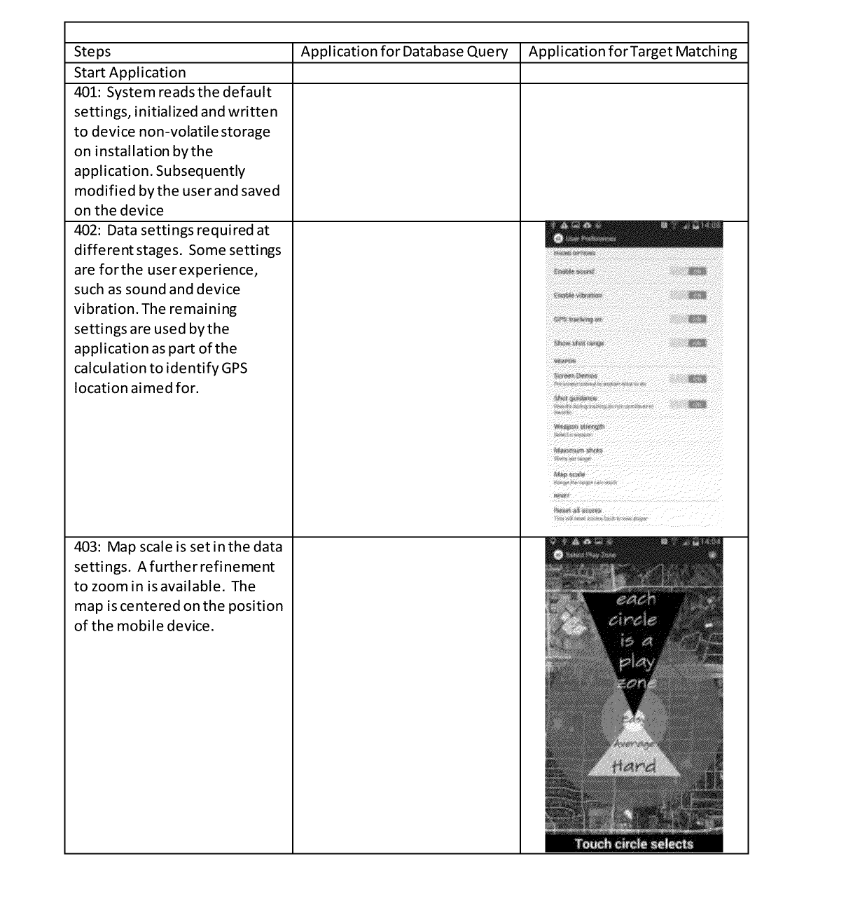

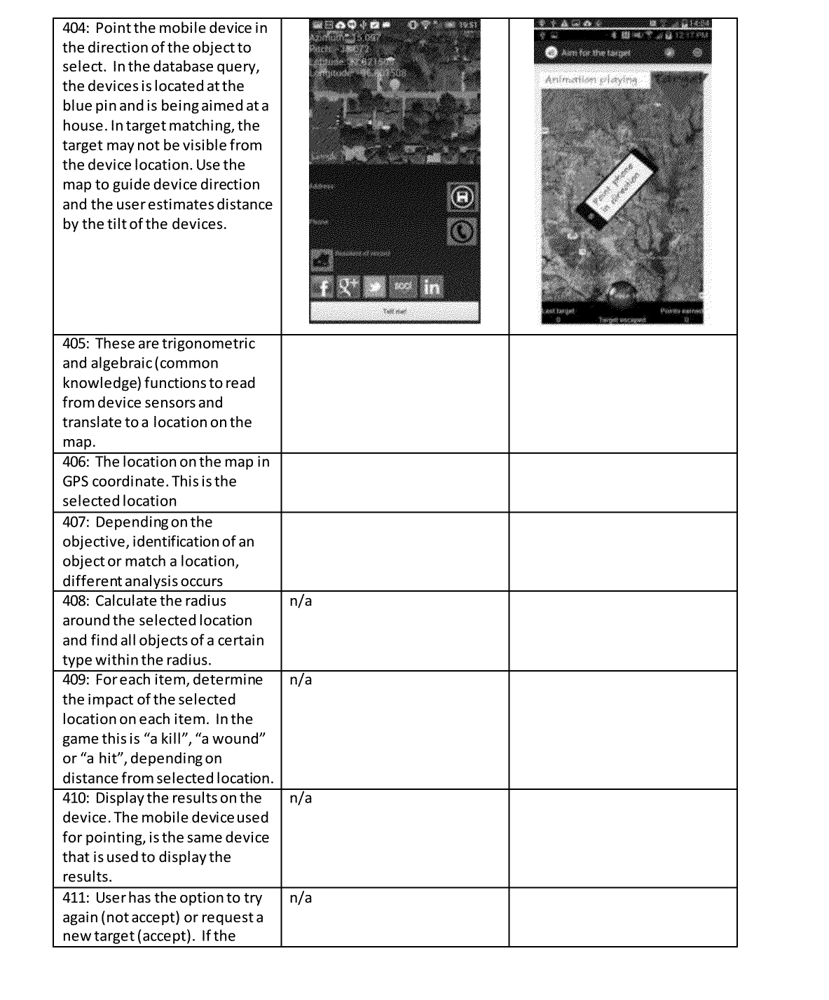

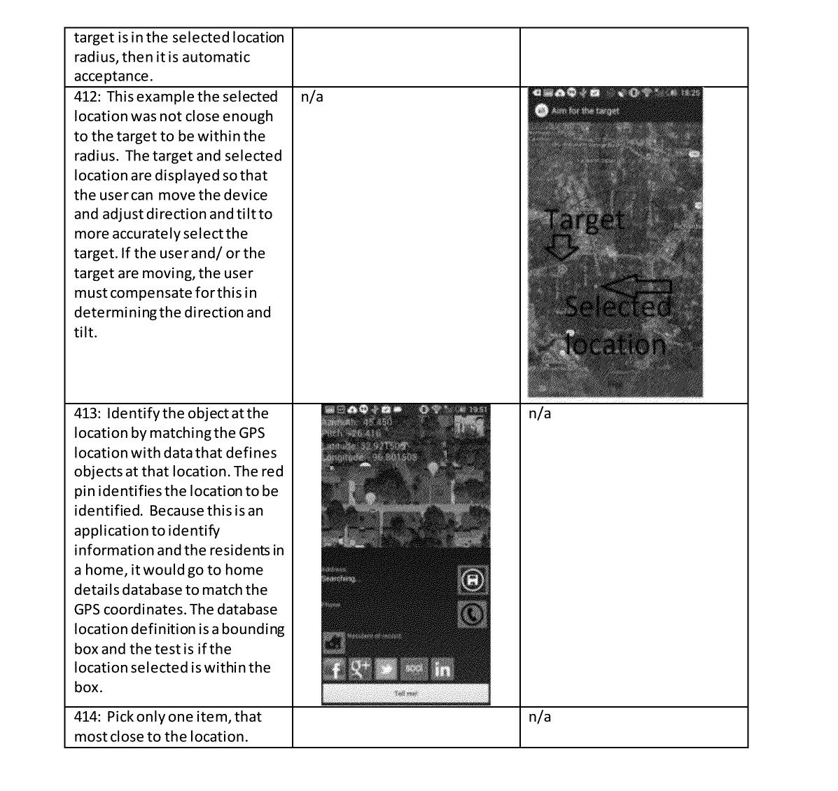

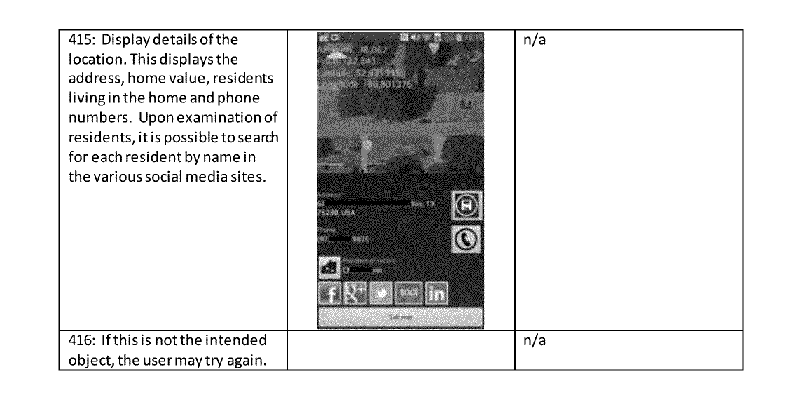

### FIG. 6:

601: Demonstrates how a user might hold a device for the purpose of selecting a target. On the device display is a map of the zone, and the current location of the device (user). Direction (compass reading in degrees) and tilt (in degrees) are displayed on the screen.

602: Demonstrates the distance (pink circle) that will be selected at that tilt. Tilt is proportional to distance from the center to the zone edge (blue circle). The angle proportion can be configured to any proportion relative to the zone edge. It works with any map scale as small as a city block to half of earth (curvature makes selection at the edges very difficult).

603: As 602 with a higher tilt.

604: As 602/603 with a tilt similar to that depicted on 601.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding actions and equivalents of all means or step plus function elements in the claims are intended to include any action for performing the function in combination with other claimed elements as specifically claimed. The description of the present invention has been presented for purposes of illustration and description, but is not intended to be exhaustive or limited to the invention in the form disclosed. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention. The embodiments were chosen and described in order to best explain the principles of the invention and the practical application, and to enable others of ordinary skill in the art to understand the invention for various embodiments with various modifications as are suited to the particular use contemplated.

As mentioned above, while exemplary embodiments of the present invention have been described in connection with various computing devices, the underlying concepts can be applied to any computer device or system in which direction and tilt information can be obtained in an application.

The various techniques described herein can be implemented in connection with hardware and software in combination of both. Thus, the methods and apparatus of the present invention, or certain aspects or portions thereof, can take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the present invention. In the case of program code execution on programmable computers, the computing device will generally include a processor, a storage medium readable by the processor (including volatile and non-volatile memory and/or storage elements), at least one output device, typically an LCD. The program(s) can be implemented in any language, for example, java (Android) Objective C (or Swift) C++, C#, if desired. In any case, the language can be a compiled or interpreted language, and combined with hardware implementations.

The embodiment of a system and method comprising a hand-held game device as described herein provides an improved user game experience over games not possessing the herein described capabilities. Also, the game is capable of leaving a more favorable impression with the user. By rotating the hand-held device to different direction and at different tilt, any location within a zone can be selected. This makes games into first person action instead of the existing third person (view down). With a map and targets, utilization of the mobile device is a significant improvement for the user experience. Point and shoot, it's the same experience as pointing a laser light in laser tag. No other devices are required besides the mobile device for viewing, aiming and firing at the target.

While the present invention has been described in connection with the preferred embodiments of the various figures, it is to be understood that other similar embodiments may be used or modifications and additions may be made to the described embodiments for performing the same function of the present invention without deviating therefrom. Therefore, the present invention should not be limited to any single embodiment, but rather should be construed in breadth and scope in accordance with the appended claims

1. (canceled)

2. (canceled)

3. (canceled)

4. A mobile application for measuring a distance and identifying an object on a mobile device, system, comprising:
(a) a GPS sensor to determine a location;
(b) an electronic compass to measure an orientation of the mobile device;
(c) a rotation vector to display a direction from the compass;
(d) on electronic accelerometer to measure tilt and motion;
(e) an angle of a mobile device to calculate a distance; and
(f) a panel display to display the location.

5. The system of claim 4, wherein the GPS sensor identifies the location based on map display.

6. The system of claim 4, wherein the angle calculates the distance using the accelerometer and rotation vector.

7. A method for measuring a distance and identifying an object on a mobile device, comprising the steps of:
(a) Displaying a selected location on a map;
(b) Determining a direction of the mobile device point and an angle of the mobile device from any angle to the Earth;
(c) Calculating a distance based on the mobile device angle and the map scale to identify an object GPS location;
(d) Identifying the object on the mobile device based on the GPS location;
(e) Providing, information of the object to a mobile device user;
wherein the information identifies the object at the direction and angle.

8. The method of claim 7, wherein the direction includes a compass direction from a rotation vector and angle of the mobile device.

9. The method of claim 7, further comprising, using an accelerometer and map scale to calculate the distance.

10. A method for measuring a distance on a mobile device, comprising the steps of:
(a) Selecting a start location;
(b) Detecting a direction of the mobile device pointing and an angle of the mobile device from any angle to the Earth;
(c) Calculating a distance based on the mobile device angle and the map scale to identify a range from the center point;
(d) Identifying the distance from the selected location to the object GPS location;
(e) Calculating, and identifying the distance when the mobile device direction and angle change.

11. The method of claim 10, wherein the start location is selected from a group consisting of mobile device location and any designated location on a map.

12. The method of claim 10, further comprising, displaying the start location on the mobile device;

13. The method of claim 10, further comprising, signifying the distance from the mobile device location to the object GPS location, wherein the signification is provided to the mobile device.

14. A method for measuring distance and identifying an object on a mobile device, comprising the steps of:
(a) Identifying at least one object on a mobile device;
(b) Detecting a direction of the mobile device pointing and an angle of the mobile device;
(c) Calculating a distance based on the mobile device angle and the map scale to identify an object GPS location;
(d) Providing information of the object to a mobile device user wherein the information identifies the object at the direction and angle.

15. The method of claim 14, wherein the object is moveable.

16. The method of claim 14, further comprising, selecting a center point for a radius of a circle surrounding ail moveable objects.

17. The method of claim 16, wherein the circle is defined by the center point and the radius.
